(19) United States
(12) Patent Application Publication
(10) Pub. No.: US 2026/0036742 A1
(43) Pub. Date: Feb. 5, 2026

(54) ANTI-RESONANT HOLLOW CORE OPTICAL FIBER WITH CONTACTING CAPILLARIES

(71) Applicant: CORNING INCORPORATED, CORNING, NY (US)

(72) Inventors: Paulo Clovis Dainese, JR., Painted Post, NY (US); Ming-Jun Li, Horseheads, NY (US); Dan Trung Nguyen, Painted Post, NY (US); Ilia Andreyevich Nikulin, Leland, NC (US)

(21) Appl. No.: 19/276,734

(22) Filed: Jul. 22, 2025

Related U.S. Application Data
(60) Provisional application No. 63/679,028, filed on Aug. 2, 2024.

(51) Int. Cl. G02B 6/032; C03B 37/027; G02B 6/02

(52) U.S. Cl. CPC G02B 6/032; C03B 37/02781; G02B 6/02342

(57) ABSTRACT

An anti-resonant hollow core optical fiber including: (a) a cladding tube including a cladding inner surface at a cladding inner radius from a fiber longitudinal axis, the cladding inner radius varying azimuthally around the fiber longitudinal axis, the cladding inner surface defining recesses, and each of the recesses merging with adjacent recesses so that the cladding inner surface forms peaks pointing inward toward the fiber longitudinal axis; (b) a plurality of primary capillaries, each of the plurality of primary capillaries (i) disposed within a different one of the recesses and contacting the cladding inner surface and (ii) contacting or merging with an adjacent primary capillary in both azimuthal directions around the fiber longitudinal axis; and (c) an effective core region tangential to the plurality of primary capillaries at a core radius from the fiber longitudinal axis, the plurality of primary capillaries disposed radially outward of the effective core region.

This application claims the benefit of priority to U.S. Provisional Patent Application Ser. No. 63/679,028 filed on Aug. 2, 2024, the content of which is relied upon and incorporated herein by reference in its entirety.

### TECHNICAL FIELD

The present disclosure pertains to anti-resonant hollow core optical fibers and, more particularly, to anti-resonant hollow core optical fibers that include primary capillaries that contact each other and are set within recesses of a cladding tube.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Optical fiber often includes a solid core through which the electromagnetic radiation moves and a cladding surrounding the solid core to maintain the electromagnetic radiation within the solid core. The cladding and the solid core exhibit different indices of refraction, and the difference causes the electromagnetic radiation to stay generally within the solid core during transmission due to total internal reflection. The solid core of the optical fiber is often formed of silica-based glass.

Transmission performance of optical fibers with a solid core can suffer from confinement loss and losses due to scattering, absorption, and bending. Imperfection in the material of the solid core can cause scattering and absorption of the electromagnetic radiation pulses that the optical fiber is transmitting. Further losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow core optical fibers are under development. Hollow core optical fibers mitigate attenuation of optical signals and provide further advantages such as low non-linearity, low dispersion, and low latency. Hollow core optical fibers, as the name suggests, do not include a core of solid material. Rather, the core is a gas, such as air. Due to the absence of a solid core, it is thought that the electromagnetic radiation could transmit without as much scattering and absorption loss.

There is still the issue of confinement of the electromagnetic radiation within the core. A category of hollow core optical fibers relies upon anti-resonance between the core and the cladding to confine the electromagnetic radiation within the core and to prevent leakage of modes into the cladding. Those optical fibers are sometimes referred to as anti-resonant hollow core optical fibers, or AR-HCFs for short. With AR-HCFs, a central hollow core is surrounded by anti-resonant cladding elements contained in a cladding tube. The anti-resonant cladding elements can be made of relatively thin glass to realize an anti-resonant effect. Anti-resonance occurs when electromagnetic radiation within any of the anti-resonant cladding elements destructively interferes with itself, resulting in minimum transmission of optical power through the glass of the anti-resonant element. The greater the anti-resonant effect of the cladding elements, the greater the confinement of electromagnetic radiation within the core, and thus the lower the confinement loss.

Engineering and design of anti-resonant cladding elements to achieve better confinement loss across desirable wavelength ranges is an evolving field of endeavor. In addition, there is a practical problem in that AR-HCFs are difficult to manufacture at large scale. The anti-resonant cladding elements must satisfy exacting structural requirements to perform efficiently and are highly sensitive to dimensional fluctuations expected from manufacturing variability. For example, if anti-resonant cladding elements designed not to contact each other but do as a result of manufacturing imprecision, the anti-resonant hollow core optical fiber exhibits peaks in confinement loss as a function of wavelength. Further, inaccuracies in the azimuthal position of the anti-resonant cladding elements relative to each other impacts the confinement loss. Furthermore, it is difficult to manufacture the anti-resonant hollow core optical fiber where the anti-resonant cladding elements do not make contact and/or where the anti-resonant cladding elements are drawn in their as-designed azimuthal position.

### SUMMARY

The present disclosure addresses those problems, and others, with an anti-resonant hollow core optical fiber that includes a cladding tube with recesses within which primary capillaries are disposed and dimensioned so that adjacent primary capillaries contact each other. The anti-resonant hollow core optical fiber is designed to avoid sharp attenuation peaks in the attenuation spectrum despite contact of the primary capillaries The anti-resonant hollow core optical fiber becomes easier to manufacture because contact between adjacent primary capillaries stabilizes the structure and makes it less sensitive to variabilities in manufacturing. The recesses further stabilize the structure by preventing the primary capillaries from rotating or moving azimuthally relative to each other and the cladding tube during manufacture. The cladding tube, having an inner surface with recesses forming peaks extending toward a center of the cladding tube, fills in the space radially outward of the primary capillaries. The recesses are depressions that increase the distance of the inner surface of the cladding tube and the primary capillaries from the hollow core to mitigate leakage of the fundamental mode through the primary capillaries to the cladding tube thereby improving confinement of the fundamental mode. So not only is manufacturing of the hollow core optical fiber easier but performance is improved as the fundamental mode exhibits low confinement loss and a smooth attenuation spectrum. At the same time, confinement loss for higher order modes is relatively high, which is beneficial for single mode transmission.

According to a first aspect of the present disclosure, an anti-resonant hollow core optical fiber comprises: (1) a fiber longitudinal axis extending from a first fiber end to a second fiber end; (2) a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis, wherein the cladding inner radius is azimuthally variable around the fiber longitudinal axis and the cladding inner surface defines a plurality of recesses; (3) a plurality of primary capillaries arranged azimuthally around the fiber longitudinal axis, each of the plurality of primary capillaries (a) disposed within a different one of the plurality of recesses and contacting the cladding inner surface, (b) contacting or merging with an adjacent primary capillary in both azimuthal directions around the fiber longitudinal axis, and (c) comprising (i) a primary longitudinal axis that is parallel to the fiber longitudinal axis, (ii) a primary outer surface at a primary outer radius from the primary longitudinal axis, and (iii) a primary inner surface at a primary inner radius from the primary longitudinal axis, the primary inner surface defining a primary interior; and (4) an effective core region tangential to the plurality of primary capillaries at a core radius from the fiber longitudinal axis, the plurality of primary capillaries disposed radially outward of the effective core region.

According to a second aspect of the present disclosure, the anti-resonant hollow core optical fiber of the first aspect is presented, wherein each of the plurality of recesses merges with an adjacent recess in both azimuthal directions around the fiber longitudinal axis so that the cladding inner surface forms peaks pointing inward toward the fiber longitudinal axis.

According to a third aspect of the present disclosure, the anti-resonant hollow core optical fiber of the first aspect is presented, wherein the cladding inner surface further defines plateau portions where the cladding inner radius is constant azimuthally around the fiber longitudinal axis, and each of the plurality of recesses are separated from an adjacent recess in both azimuthal directions around the fiber longitudinal axis by a different one of the plateau portions.

According to a fourth aspect of the present disclosure, the anti-resonant hollow core optical fiber of any one of the first through third aspects is presented, wherein the primary outer radius of each of the plurality of primary capillaries is within a range of from 5 μm to 30 μm.

According to a fifth aspect of the present disclosure, the anti-resonant hollow core optical fiber of any one of the first through fourth aspects is presented, wherein each of the plurality of primary capillaries further comprises a primary thickness that is within a range of from 250 nm to 1500 nm.

According to a sixth aspect of the present disclosure, the anti-resonant hollow core optical fiber of any one of the first through fifth aspects is presented, wherein each of the plurality of primary capillaries further comprises a primary thickness that is within ±30% of a calculated thickness t as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the primary capillaries.

According to a seventh aspect of the present disclosure, the anti-resonant hollow core optical fiber of any one of the first through sixth aspects is presented, wherein (i) the cladding tube has from 3 to 9 recesses, (ii) the anti-resonant hollow core optical fiber has from 3 to 9 primary capillaries, and (iii) the quantity of recesses and the quantity of primary capillaries are the same.

According to an eighth aspect of the present disclosure, the anti-resonant hollow core optical fiber of any one of the first through seventh aspects is presented, wherein the core radius is within a range of from 10 μm to 25 μm.

According to a ninth aspect of the present disclosure, the anti-resonant hollow core optical fiber of any one of the first through eighth aspects further comprises: a capillary region radius that is tangential to the primary outer surface of each of the plurality of primary capillaries but radially outward of the core radius; and a primary capillary region between the capillary region radius and the core radius, each of the plurality of primary capillaries disposed entirely within the primary capillary region.

According to a tenth aspect of the present disclosure, the anti-resonant hollow core optical fiber of the ninth aspect is presented, wherein the cladding tube occupies an entirety of a volume, outside of the plurality of primary capillaries, that is radially inward of the capillary region radius and radially outward of where adjacent primary capillaries contact or merge.

According to an eleventh aspect of the present disclosure, the anti-resonant hollow core optical fiber of the ninth aspect is presented, wherein (i) bury radial lines extend from the longitudinal axis radially outward through the cladding tube, each of the bury radial lines extending through where different pairs of adjacent primary capillaries contact or merge, and (ii) the cladding tube occupies a portion of a volume, outside of the plurality of primary capillaries that is radially inward of the capillary region radius to a depth from the capillary region radius along each of the bury radial longs toward where the adjacent primary capillaries contact or merge.

According to a twelfth aspect of the present disclosure, the anti-resonant hollow core optical fiber of the eleventh aspect is presented, wherein the depth is from 10% to 85% of a radial distance from the capillary region radius to where the adjacent primary capillaries contact or merge.

According to a thirteenth aspect of the present disclosure, the anti-resonant hollow core optical fiber of any one of the first through twelfth aspects further comprises: a plurality of first nested capillaries extending longitudinally from the first fiber end to the second fiber end, each of the plurality of first nested capillaries (a) disposed within the primary interior of a different one of the plurality of primary capillaries and (b) comprising (i) a first capillary axis that is parallel to the fiber longitudinal axis and (ii) a first nested interior.

According to a fourteenth aspect of the present disclosure, the anti-resonant hollow core optical fiber of the thirteenth aspect is presented, wherein each of the plurality of first nested capillaries further comprises a first nested outer radius from the first capillary axis that is within a range of from 5 μm to 15 μm.

According to a fifteenth aspect of the present disclosure, the anti-resonant hollow core optical fiber of any one of the thirteenth through fourteenth aspects is presented, wherein each of the plurality of first nested capillaries further comprises a first nested thickness that is within a range of from 250 nm to 1500 nm.

According to a sixteenth aspect of the present disclosure, the anti-resonant hollow core optical fiber of any one of the thirteenth through fourteenth aspects is presented, wherein each of the plurality of first nested capillaries further comprises a first nested thickness that is within ±30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the first nested capillaries.

According to a seventeenth aspect of the present disclosure, the anti-resonant hollow core optical fiber of any one of the thirteenth through sixteenth aspects further comprises: a plurality of second nested capillaries extending longitudinally from the first fiber end to the second fiber end, each of the plurality of second nested capillaries (a) disposed within the primary interior of a different one of the plurality of primary capillaries along with a different one of the plurality of first nested capillaries and (b) comprising (i) a second capillary axis that is parallel to the fiber longitudinal axis and (ii) a second nested interior.

According to an eighteenth aspect of the present disclosure, the anti-resonant hollow core optical fiber of the seventeenth aspect is presented, wherein each of the plurality of second nested capillaries further comprises a second nested outer radius from the second capillary axis that is within a range of from 5 μm to 15 μm.

According to a nineteenth aspect of the present disclosure, the anti-resonant hollow core optical fiber of any one of the seventeenth through eighteenth aspects is presented, wherein each of the plurality of second nested capillaries further comprises a second nested thickness that is within a range of from 250 nm to 1500 nm.

According to a twentieth aspect of the present disclosure, the anti-resonant hollow core optical fiber of any one of the seventeenth through eighteenth aspects is presented, wherein each of the plurality of second nested capillaries further comprises a second nested thickness that is within ±30% of a calculated thickness defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the second nested capillaries.

According to a twenty-first aspect of the present disclosure, the anti-resonant hollow core optical fiber of any one of the seventeenth through twentieth aspects is presented, wherein (a) a series of primary radial lines extend from the fiber longitudinal axis through (i) the primary longitudinal axis of each of the plurality of primary capillaries and (ii) through the cladding inner surface, and (b) each of the plurality of first nested capillaries is paired with a different one of the plurality of second nested capillaries within a different one of the plurality of primary capillaries, the first nested capillary disposed to one side of the primary radial line and the second nested capillary disposed to another side of the primary radial line.

According to a twenty-second aspect of the present disclosure, the anti-resonant hollow core optical fiber of the twenty-first aspect is presented, wherein a first nested radial line extending from the primary longitudinal axis through the first capillary axis forms a first angle within a range of from 70 degrees to 110 degrees relative to the primary radial line.

According to a twenty-third aspect of the present disclosure, the anti-resonant hollow core optical fiber of the twenty-second aspect is presented, wherein a second nested radial line extending from the primary longitudinal axis through the second capillary axis forms a second angle within a range of from 70 degrees to 110 degrees relative to the primary radial line.

According to a twenty-fourth aspect of the present disclosure, the anti-resonant hollow core optical fiber of any one of the first through twenty-third aspects is presented, wherein the anti-resonant hollow core optical fiber exhibits a confinement loss for the fundamental mode of electromagnetic radiation throughout an entirety of a wavelength range of from 1500 nm to 1600 nm that is less than or equal to 0.50 dB/km.

According to a twenty-fifth aspect of the present disclosure, the anti-resonant hollow core optical fiber of any one of the first through twenty-fourth aspects is presented, wherein the anti-resonant hollow core optical fiber exhibits a confinement loss for higher order modes of electromagnetic radiation throughout an entirety of a wavelength range of from 1500 nm to 1600 nm that is greater than or equal to 100 dB/km.

According to a twenty-sixth aspect of the present disclosure, a method of manufacturing an anti-resonant hollow core optical fiber comprises: (a) a preform recess formation step comprising forming a plurality of preform recesses into a cladding preform inner surface of a cladding preform tube through which a cladding preform longitudinal axis extends, each of the plurality of preform recesses (i) disposed longitudinally from a first preform end to a second preform end of the cladding preform tube and (ii) merging with an adjacent preform recess in both azimuthal directions around the preform longitudinal axis so that the cladding preform inner surface forms peaks pointing inward toward the cladding preform longitudinal axis; (b) a primary preform capillary arrangement step comprising arranging a plurality of primary preform capillaries within the plurality of preform recesses of the cladding preform tube thus forming an optical fiber preform, each of the plurality of primary preform capillaries (i) comprising an outer primary preform surface at an outer primary preform radius from a primary capillary preform axis parallel to the cladding preform longitudinal axis, (ii) contacting an adjacent primary preform capillary in both azimuthal directions around the cladding preform longitudinal axis, and (iii) contacting the cladding preform inner surface, wherein, the plurality of preform recesses is dimensioned to substantially match the outer primary preform surface of the plurality of primary preform capillaries; and (c) a drawing step comprising drawing an anti-resonant hollow core optical fiber from the optical fiber preform.

According to a twenty-seventh aspect of the present disclosure, the method of the twenty-sixth aspect is presented, wherein each of the plurality of preform recesses merge with an adjacent preform recess in both azimuthal directions around the preform longitudinal axis so that the cladding preform inner surface forms peaks pointing inward toward the cladding preform longitudinal axis.

According to a twenty-eighth aspect of the present disclosure, the method of the twenty-sixth aspect is presented, wherein the cladding preform inner surface forms plateaus of constant radius from the cladding preform longitudinal axis between adjacent preform recesses in both azimuthal directions around the preform longitudinal axis.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of an anti-resonant hollow core optical fiber of the present disclosure, illustrating a cladding tube, primary capillaries disposed within the cladding tube, a plurality of first nested capillaries, and a plurality of second nested capillaries;

FIG. 2 is a cross-sectional view of the anti-resonant hollow core optical fiber taken through line II-II of FIG. 1, illustrating the cladding tube (but not the primary capillaries, the first nested capillaries, and the second nested capillaries, to maintain clarity) having a plurality of recesses into a cladding inner surface and forming peaks pointing toward a fiber longitudinal axis;

FIG. 3A is a cross-sectional view of the anti-resonant hollow core optical fiber taken through line IIIA-IIIA of FIG. 1, illustrating the first nested capillaries and the second nested capillaries each nested together within each of the primary capillaries and adjacent recesses forming peaks pointing toward the fiber longitudinal axis;

FIG. 3B is a cross-sectional view of the anti-resonant hollow core optical fiber taken through line IIIB-IIIB of FIG. 1, illustrating the cladding inner surface forming the plurality of recesses and plateaus between adjacent recesses so that the recesses and plateaus alternate azimuthally around the fiber longitudinal axis;

FIG. 4 is a schematic diagram of a method of making the anti-resonant hollow core optical fiber, setting forth a preform recess formation step, a primary preform capillary arrangement step, and a drawing step;

FIG. 5 is a schematic diagram of the preform recess formation step, illustrating a plurality of recesses having been formed into a cladding preform inner surface of a cladding preform tube;

FIG. 6 is a schematic diagram of the primary preform capillary arrangement step, illustrating a plurality of primary preform capillaries having been coupled to the cladding preform inner surface within the plurality of recesses, with adjacent primary preform capillaries contacting each other;

FIG. 7 is a cross-sectional view taken along line VII-VII of FIG. 6, illustrating outer primary preform surfaces of adjacent primary preform capillaries contacting;

FIG. 8 is a schematic diagram of the drawing step, illustrating the anti-resonant hollow core optical fiber being drawn from the optical fiber preform;

FIG. 9, pertaining to an Example, is a graph plotting confinement loss for the fundamental mode as a function of wavelength of electromagnetic radiation for embodiments of the anti-resonant hollow core optical fiber (i) with no overlap between the primary capillaries and the cladding inner surface of the cladding tube and (ii) with 200 nm overlap between the primary capillaries and the cladding inner surface of the cladding tube;

FIG. 10 is a graph plotting confinement loss for both (i) the fundamental mode and (ii) higher order modes as a function of wavelength of electromagnetic radiation for embodiments of the anti-resonant hollow core optical fiber; and

FIG. 11 is a graph plotting confinement loss for the fundamental mode as a function of bending radius of the anti-resonant hollow core optical fiber.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

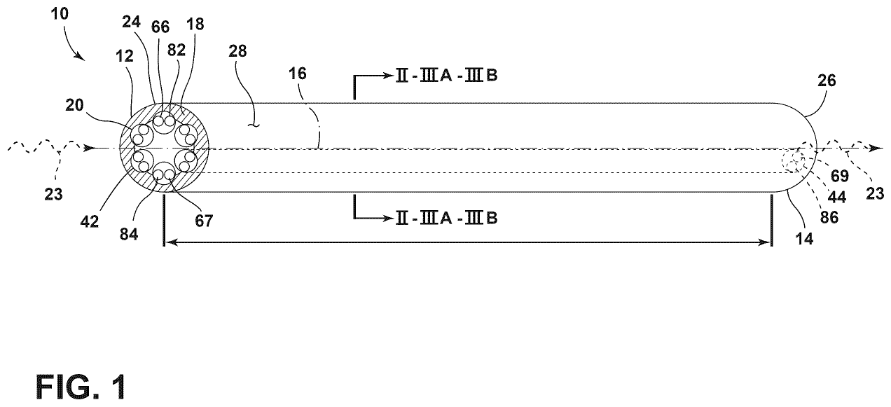

Referring to FIGS. 1-3B, an anti-resonant hollow core optical fiber 10 includes a first fiber end 12, a second fiber end 14, a fiber longitudinal axis 16, a cladding tube 18, a plurality of primary capillaries 20, and an effective core region 22. The fiber longitudinal axis 16 extends from the first fiber end 12 to the second fiber end 14. In use, electromagnetic radiation 23 enters into the first fiber end 12, transmits predominantly within the effective core region 22, and exits the second fiber end 14.

The cladding tube 18 likewise extends, azimuthally around the fiber longitudinal axis 16, from the first fiber end 12 to the second fiber end 14. The cladding tube 18 includes a first cladding end 24 and a second cladding end 26. The first cladding end 24 is proximate, and may at least partially define, the first fiber end 12. The second cladding end 26 is proximate, and may at least partially define, the second fiber end 14.

The cladding tube 18 further includes a cladding outer surface 28 and a cladding inner surface 30. The cladding outer surface 28 is at a cladding outer radius 32 from the fiber longitudinal axis 16. The cladding inner surface 30 is at a cladding inner radius 34 from the fiber longitudinal axis 16. The cladding inner surface 30 defines a cladding interior 36. The cladding inner radius 34 varies as a function of azimuthal position around the fiber longitudinal axis 16. The cladding inner surface 30 thus defines a plurality of recesses 38.

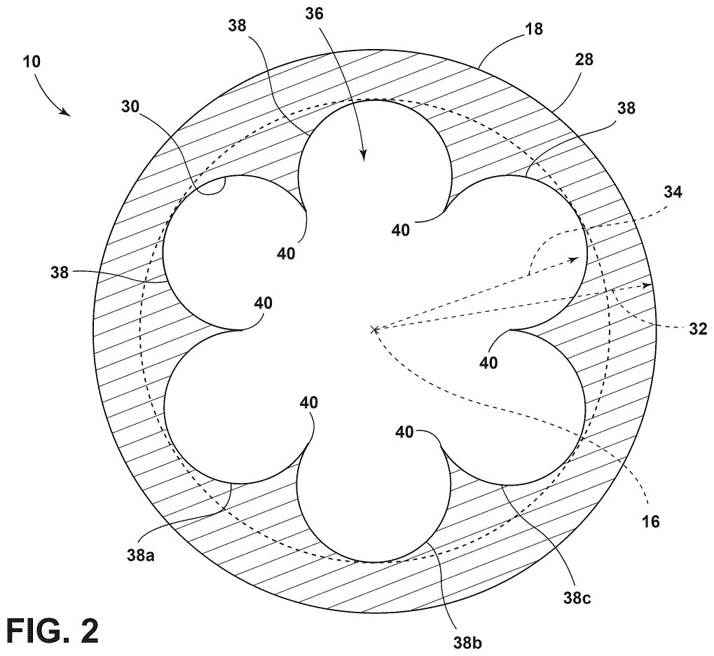

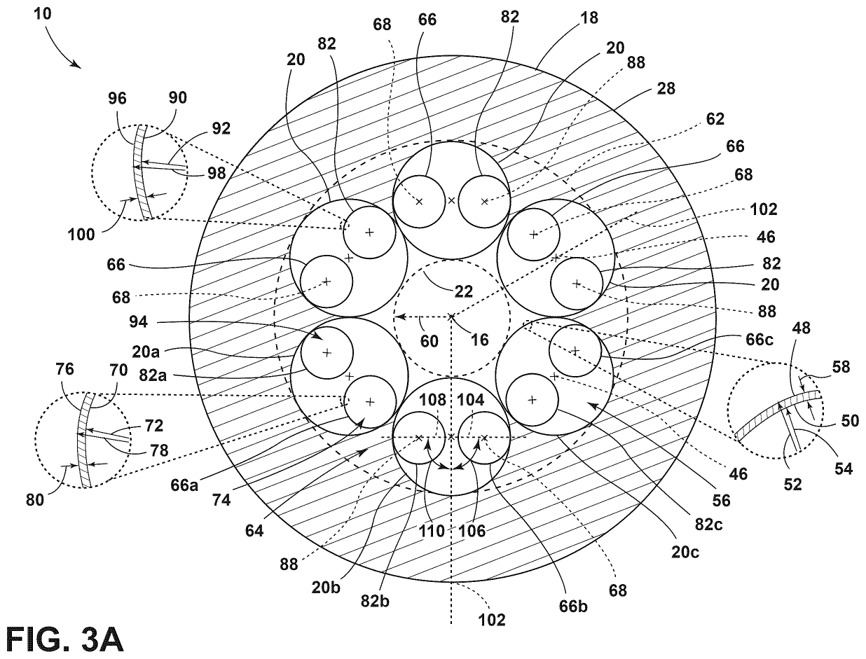

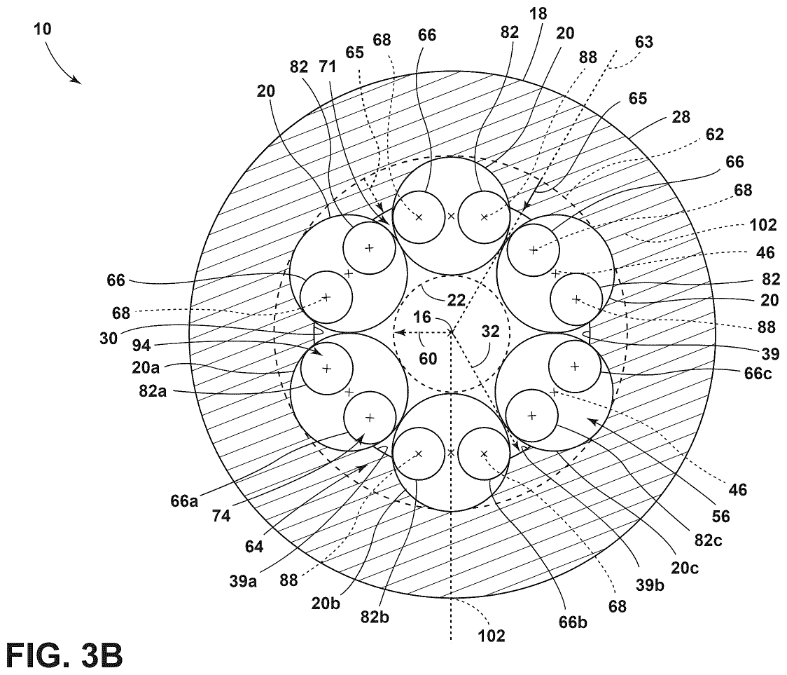

In embodiments (see FIGS. 2 and 3A), each of the plurality of recesses 38 merges with an adjacent recess 38 in both azimuthal directions around the fiber longitudinal axis 16. For example, the recess 38b merges with the recess 38c in one azimuthal direction around the fiber longitudinal axis 16 and additionally with the recess 38a in the other azimuthal direction. The bi-directional merging of the plurality of recesses 38 thus forms peaks 40. The peaks 40 point inward toward the fiber longitudinal axis 16. The peaks 40 are disposed azimuthally around the fiber longitudinal axis 16.

In other embodiments (FIG. 3B), the cladding inner surface 30 presents both the plurality of recesses 38 where the cladding inner radius 34 varies azimuthally around the fiber longitudinal axis 16 and plateau portions 39 where the cladding inner radius 34 is constant azimuthally around the fiber longitudinal axis 16. The cladding inner surface 30 alternates between the recesses 38 and the plateau portions 39 azimuthally around the fiber longitudinal axis 16. Each one of the plateau portions 39 are disposed between different pairs of adjacent recesses 38. Each of the plurality of recesses 38 are separated from the adjacent recess 38 in both azimuthal directions around the fiber longitudinal axis 16 by a different one of the plateau portions 39.

The plurality of primary capillaries 20 is disposed within the cladding interior 36. The plurality of primary capillaries 20 is arranged azimuthally around the fiber longitudinal axis 16. Each of the plurality of primary capillaries 20 includes a capillary first end 42 and a capillary second end 44. The capillary first end 42 is proximate, and may at least partially define, the first fiber end 12. The capillary second end 44 is proximate, and may at least partially define, the second fiber end 14.

Each of the plurality of primary capillaries 20 further includes a primary longitudinal axis 46 that is parallel to the fiber longitudinal axis 16. In addition, each of the plurality of primary capillaries 20 further includes a primary outer surface 48 and a primary inner surface 50. The primary outer surface 48 is at a primary outer radius 52 from the primary longitudinal axis 46. The primary inner surface 50 is at a primary inner radius 54 from the primary longitudinal axis 46. The primary inner surface 50 defines a primary interior 56. In embodiments, the primary outer radius 52 is within a range of from 5 μm to 30 μm. For example, the primary outer radius 52 can be 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, or within any range bound by any two of those values (e.g., from 25 μm to 29 μm, from 18 μm to 24 μm, from 10 μm to 25 μm, from 12 μm to 20 μm, and so on). The primary outer radius 52 can be less than 18 μm or greater than 30 μm.

Each of the plurality of primary capillaries 20 further includes a primary thickness 58. The primary thickness 58 is the distance measured radially from the primary longitudinal axis 46 between the primary inner surface 50 and the primary outer surface 48. In embodiments, the primary thickness 58 is within a range of from 250 nm to 1500 nm. For example, the primary thickness 58 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the primary thickness 58 is within ±30%, ±25%, ±20%, ±15%, ±10%, or ±5% of a calculated thickness/as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and nis the refractive index of the primary capillaries.

Each of the plurality of primary capillaries 20 is disposed within a different one of the plurality of recesses 38. For example, the primary capillary 20a is disposed within the recess 38a, the primary capillary 20b is disposed within the recess 38b, and the primary capillary 20c is disposed within the recess 38c. Each of the primary capillaries 20 contacts the cladding inner surface 30 and can be fused thereto. Each of the primary capillaries 20 contacts or merges with an adjacent one of the primary capillaries 20 in both azimuthal directions around the fiber longitudinal axis 16. For example, the primary capillary 20b contacts or merges with the primary capillary 20c in one azimuthal direction, and the primary capillary 20b contacts or merges with the primary capillary 20a in the other azimuthal direction.

In embodiments of the anti-resonant hollow optical fiber 10 that include the plateaus 39 of the cladding inner surface 30 (see FIG. 3B), the plurality of primary capillaries 20 and the plateaus 39 alternate azimuthally around the fiber longitudinal axis 16. For example, plateau 39a is disposed between capillary 20a and capillary 20b, and plateau 39b is disposed between capillary 20b and capillary 20c.

The anti-resonant hollow core optical fiber 10 can have any number of primary capillaries 20. In embodiments, the cladding tube 18 has a quantity of recesses 38 that is equal to the number of primary capillaries 20 of the anti-resonant hollow core optical fiber 10. In embodiments, the cladding tube 18 has from 3 to 9 recesses 38. For example, the cladding tube 18 can have 3, 4, 5, 6, 7, 8, or 9 recesses 38. The cladding tube 18 could have less than 3 or greater than 9 recesses 38. The anti-resonant hollow core optical fiber 10 can include from 3 to 9 primary capillaries 20. For example, the anti-resonant hollow core fiber can have 3, 4, 5, 6, 7, 8, or 9 primary capillaries 20. The anti-resonant hollow core optical fiber 10 could have less than 3 or greater than 9 primary capillaries 20.

The effective core region 22 is within the cladding interior 36. The effective core region 22 is tangential to the primary outer surface 48 of each of the plurality of primary capillaries 20. The effective core region 22 is at a core radius 60 from the fiber longitudinal axis 16. The effective core region 22 extends between the first fiber end 12 and the second fiber end 14. The plurality of primary capillaries 20 is disposed radially outward of the effective core region 22. In embodiments, the core radius 60 is within a range of from 5 μm to 100 μm. For example, the core radius 60 can be 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, or within any range bound by any two of those values (e.g., from 11 μm to 18 μm, from 14 μm to 17 μm, from 45 μm to 75 μm, from 50 μm to 95 μm, and so on).

In embodiments, the anti-resonant hollow core optical fiber 10 further includes a capillary region radius 62 and a primary capillary region 64. The capillary region radius 62 is tangential to the primary outer surface 48 of each of the plurality of primary capillaries 20 but radially outward of the core radius 60. The primary capillary region 64 is disposed between the capillary region radius 62 and the core radius 60. Each of the plurality of primary capillaries 20 is disposed entirely within the primary capillary region 64.

In embodiments (see FIG. 3A), the cladding tube 18 occupies an entirety of the primary capillary region 64, outside of the primary capillaries 20, that is radially inward of the capillary region radius 62 and radially outward of where adjacent primary capillaries 20 contact or merge. Stated another way, in those embodiments, the anti-resonant hollow core optical fiber 10 is substantially free of air gaps within the primary capillary region 64 created by the cladding inner surface 30 and the primary outer surfaces 48 of adjacent primary capillaries 20 radially inward of the cladding inner surface 30. “Substantially free” here means that the anti-resonant hollow core optical fiber 10 is designed to be free of such air gaps but manufacturing imprecision may result in the generation of such air gaps.

In other embodiments (see FIG. 3B), where the plurality of recesses 38 stop short of merging and instead the inner cladding surface 30 forms the plateaus 39, the cladding tube 18 does not occupy an entirety of the primary capillary region 64, outside of the primary capillaries 30, that is radially inward of the capillary region radius 62 and radially outward of where adjacent primary capillaries 20 contact or merge. As a conceptual tool, for these embodiments, bury radial lines 63 extend from the fiber longitudinal axis 16 and radially outward through the cladding tube. Each of the bury radial lines 63 extend through a different one of the plateaus 39 and where a different pairs of the primary capillaries 20 contact or merge. The plateaus 39 reside at a depth 65 from the capillary region radius 62 along each of the bury radial lines 63 toward the fiber longitudinal axis 16. The cladding tube 18 occupies a portion of the volume (e.g., a portion of the primary capillary region 64), outside of the plurality of primary capillaries 30, that is radially inward of the capillary region radius 62 to the depth 65 from the capillary region radius 62 along each of the bury radial lines 63 toward where the adjacent primary capillaries 20 contact or merge. Air pockets 71 occupy the volume between the plateau 39 of the inner cladding surface 30 and where adjacent primary capillaries 20 contact or merge. The air pockets 71 are arranged azimuthally around the fiber longitudinal axis 16. The depth 65 can be from greater than 0% of a radial distance from the capillary region radius 62 to where the adjacent primary capillaries 20 contact or merge to less than 100% of that radial distance. For example, the depth 65 can be 10%, 15%, 20%, 25%, 30%, 35%, 40%, 45%, 50%, 55%, 60%, 65%, 70%, 75%, 85%, or within any range bound by any two of those values of that radial distance (e.g., from 20% to 60%, from 15% to 40%, and so on). Further, the depth 65 can be greater than 0 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, 36 μm, 37 μm, 38 μm, 39 μm, 40 μm, or within any range bound by any two of those values (e.g., from greater than 0 μm to 40 μm, from 10 μm to 30 μm, and so on).

In embodiments, the anti-resonant hollow core optical fiber 10 further includes a plurality of first nested capillaries 66. The plurality of first nested capillaries 66 extends longitudinally within the cladding tube 18 from the first fiber end 12 to the second fiber end 14. Each of the plurality of first nested capillaries 66 includes an end 67 (see FIG. 1) disposed proximate the first cladding end 24 and can at least partially define the first fiber end 12. Each of the first nested capillaries 66 includes another end 69 disposed proximate the second cladding end 26 and can at least partially define the second fiber end 14.

Each of the first nested capillaries 66 is disposed within the primary interior 56 of a different one of the plurality of primary capillaries 20. Each of the first nested capillaries 66 includes a first capillary axis 68. The first capillary axis 68 is parallel to both the fiber longitudinal axis 16 and the primary longitudinal axis 46. Each of the first nested capillaries 66 includes a first nested inner surface 70 at a first nested inner radius 72 from the first capillary axis 68. The first nested inner surface 70 defines a first nested interior 74.

Each of the first nested capillaries 66 further includes a first nested outer surface 76 at a first nested outer radius 78 from the first capillary axis 68. In embodiments, the first nested outer radius 78 is within a range of from 5 μm to 15 μm. For example, the first nested outer radius 78 can be 5 μm, 6 μm, 7 μm, 8 μm, 9 μm, 10 μm, 11 μm, 12 μm, 13 μm, 14 μm, 15 μm, or within any range bound by any two of those values (e.g., from 6 μm to 12 μm, from 8 μm to 14 μm, and so on).

Each of the first nested capillaries 66 further includes a first nested thickness 80. The first nested thickness 80 is the distance measured radially from the first capillary axis 68 between the first nested inner surface 70 and the first nested outer surface 76. In embodiments, the first nested thickness 80 is within a range of from 250 nm to 1500 nm. For example, the first nested thickness 80 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 700 nm to 1400 nm, from 800 nm to 1300 nm, and so on). In embodiments, the first nested thickness 80 is within ±30%, ±25%, ±20%, ±15%, ±10%, or ±5% of a calculated thickness/as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the first nested capillaries 66.

In embodiments, the anti-resonant hollow core optical fiber 10 further includes a plurality of second nested capillaries 82. The plurality of second nested capillaries 82 extends longitudinally from the first fiber end 12 to the second fiber end 14. Each of the plurality of second nested capillaries 82 includes an end 84 (see FIG. 1) disposed proximate the first cladding end 24 and can at least partially define the first fiber end 12. Each of the second nested capillaries 82 includes another end 86 disposed proximate the second cladding end 26 and can at least partially define the second fiber end 14.

Each of the plurality of second nested capillaries 82 is disposed within the primary interior 56 of a different one of the plurality of primary capillaries 20. Each of the second nested capillaries 82 shares the primary interior 56 of one of the primary capillaries 20 with a different one of the plurality of first nested capillaries 66. For example, the second nested capillary 82a and the first nested capillary 66a are disposed within the primary capillary 20a, the second nested capillary 82b and the first nested capillary 66b are disposed within the primary capillary 20b, the second nested capillary 82c and the first nested capillary 66c are disposed within the primary capillary 20c, and so on. Each of the second nested capillaries 82 includes a second capillary axis 88. The second capillary axis 88 is parallel to the fiber longitudinal axis 16, the primary longitudinal axis 46, and the first capillary axis 68. Each of the second nested capillaries 82 includes a second nested inner surface 90 at a second nested inner radius 92 from the second capillary axis 88. The second nested inner surface 90 defines a second nested interior 94.

Each of the second nested capillaries 82 further includes a second nested outer surface 96 at a second nested outer radius 98 from the second capillary axis 88. In embodiments, the second nested outer radius 98 is within a range of from 5 μm to 15 μm. For example, the second nested outer radius 98 can be 5 μm, 6 μm, 7 μm, 8 μm, 9 μm, 10 μm, 11 μm, 12 μm, 13 μm, 14 μm, 15 μm, or within any range bound by any two of those values (e.g., from 6 μm to 12 μm, from 8 μm to 14 μm, and so on).

Each of the second nested capillaries 82 further includes a second nested thickness 100. The second nested thickness 100 is the distance measured radially from the second capillary axis 88 between the second nested inner surface 90 and the second nested outer surface 96. In embodiments, the second nested thickness 100 is within a range of from 250 nm to 1500 nm. For example, the second nested thickness 100 is 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, 1050 nm, 1100 nm, 1150 nm, 1200 nm, 1250 nm, 1300 nm, 1350 nm, 1400 nm, 1450 nm, 1500 nm, or within any range bound by any two of those values (e.g., from 350 nm to 700 nm, from 500 nm to 850 nm, from 1150 nm to 1400 nm, and so on). In embodiments, the second nested thickness 100 is within ±30%, ±25%, ±20%, ±15%, ±10%, or ±5% of a calculated thickness/as defined by the equation:

$$t = \frac{( 2 m - 1 ) λ}{4 \sqrt{{n}^{2} - 1}}$$

where, t is the calculated thickness, m is an integer (e.g., 1, 2, 3, . . . ) corresponding to the order of antiresonance, λ is the operating wavelength, and n is the refractive index of the second nested capillaries 82.

In embodiments, a plurality of primary radial lines 102 extends from the fiber longitudinal axis 16 through (i) the primary longitudinal axis 46 of each of the plurality of primary capillaries 20 and (ii) through the cladding inner surface 30. As mentioned, each of the plurality of first nested capillaries 66 can be paired with a different one of the plurality of second nested capillaries 82 within a different one of the plurality of primary capillaries 20. In such instances, within each of the plurality of primary capillaries 20, the first nested capillary 66 is disposed to one side of the primary radial line 102 and the second nested capillary 82 is disposed to another side of the primary radial line 102. It should be understood that the plurality of primary radial lines 102 is not physical components of the anti-resonant hollow core optical fiber 10 but rather is a conceptual tool to help explain possible spatial orientation of the plurality of first nested capillaries 66 and the plurality of second nested capillaries 82 within the plurality of primary capillaries 20.

In embodiments, as another conceptual tool, within each of the plurality of primary capillaries 20, a first nested radial line 104 extends from the primary longitudinal axis 46 and through the first capillary axis 68. The first nested radial line 104 forms a first angle 106 relative to the primary radial line 102. In some instances, the first angle 106 is within a range of from 70 degrees to 110 degrees. For example, the first angle 106 can be 70 degrees, 75 degrees, 80 degrees, 85 degrees, 90 degrees, 95 degrees, 100 degrees, 105 degrees, 110 degrees, or within any range bound by any two of those values (e.g., from 80 degrees to 95 degrees, from 85 degrees to 100 degrees, and so on).

In embodiments, as another conceptual tool, within each of the plurality of primary capillaries 20, a second nested radial line 108 extends from the primary longitudinal axis 46 and through the second capillary axis 88. The second nested radial line 108 forms a second angle 110 relative to the primary radial line 102. In some instances, the second angle 110 is within a range of from 70 degrees to 110 degrees. For example, the second angle 110 can be 70 degrees, 75 degrees, 80 degrees, 85 degrees, 90 degrees, 95 degrees, 100 degrees, 105 degrees, 110 degrees, or within any range bound by any two of those values (e.g., from 80 degrees to 95 degrees, from 85 degrees to 100 degrees, and so on). The first angle 106 and the second angle 110 concern relative positioning of the first nested capillary 66 and the second nested capillary 82 within any particular of the primary capillaries 20. That relative positioning affects the ability of the anti-resonant components (e.g., the plurality of primary capillaries 20, the plurality of first nested capillaries 66, and the plurality of second nested capillaries 82) of the anti-resonant hollow core optical fiber 10 to maintain the electromagnetic radiation 23 within the effective core region 22. In that regard, in embodiments, the anti-resonant hollow core optical fiber 10 exhibits a confinement loss for the fundamental mode of electromagnetic radiation 23, throughout an entirety of a wavelength range of from 1500 nm to 1600 nm, that is less than or equal to 0.50 dB/km. For example, the confinement loss that the anti-resonant hollow core optical fiber 10 exhibits for the fundamental mode of electromagnetic radiation 23 can be less than or equal to 0.50 dB/km, less than or equal to 0.45 dB/km, less than or equal to 0.40 dB/km, less than or equal to 0.35 dB/km, less than or equal to 0.30 dB/km, less than or equal to 0.25 dB/km, less than or equal to 0.20 dB/km, or less than or equal to 0.15 dB/km. The confinement loss that the anti-resonant hollow core optical fiber 10 exhibits can be 0.15 dB/km, 0.20 dB/km, 0.25 dB/km, 0.30 dB/km, 0.35 dB/km, 0.40 dB/km, 0.45 dB/km, 0.50 dB/km, or within any range bound by any two of those values (e.g., from 0.15 dB/km to 0.30 dB/km, from 0.20 dB/km to 0.40 dB/km, and so on). In embodiments, the confinement loss for the fundamental mode of electromagnetic radiation 23, throughout an entirety of a wavelength range of from 1300 nm to 1700 nm, that is less than or equal to 0.50 dB/km.

In embodiments, the anti-resonant hollow core optical fiber 10 exhibits a confinement loss for higher order modes of electromagnetic radiation 23 throughout an entirety of the wavelength range of from 1500 nm to 1600 nm that is greater than or equal to 100 dB/km. For example, the confinement loss for higher order modes of electromagnetic radiation 23 that the anti-resonant hollow core optical fiber 10 exhibits, throughout an entirety of the wavelength range of from 1500 nm to 1600 nm, can be greater than or equal to 100 dB/km, greater than or equal to 150 dB/km, greater than or equal to 200 dB/km, greater than or equal to 250 dB/km, greater than or equal to 300 dB/km, greater than or equal to 350 dB/km, greater than or equal to 400 dB/km, greater than or equal to 450 dB/km, greater than or equal to 500 dB/km, greater than or equal to 550 dB/km, greater than or equal to 600 dB/km, greater than or equal to 650 dB/km, greater than or equal to 700 dB/km, greater than or equal to 750 dB/km, or greater than or equal to 800 dB/km. The confinement loss that the anti-resonant hollow core optical fiber 10 exhibits for higher order modes of electromagnetic radiation 23, throughout an entirety of the wavelength range of from 1500 nm to 1600 nm, can be 100 dB/km, 150 dB/km, 200 dB/km, 250 dB/km, 300 dB/km, 350 dB/km, 400 dB/km, 450 dB/km, 500 dB/km, 550 dB/km, 600 dB/km, 650 dB/km, 700 dB/km, 750 dB/km, 800 dB/km, or within any range bound by any two of those values (e.g., from 100 dB/km to 800 dB/km, from 200 dB/km to 600 dB/km, and so on). The greater the confinement loss of higher order modes, the better the signal quality of the fundamental mode.

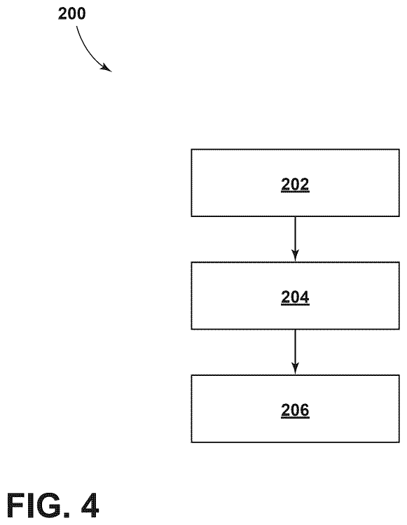

Referring now to FIGS. 4-8, a method 200 of manufacturing the anti-resonant hollow core optical fiber 10 is described herein. The method 200 includes at least a preform recess formation step 202, a primary preform capillary arrangement step 204, and a drawing step 206.

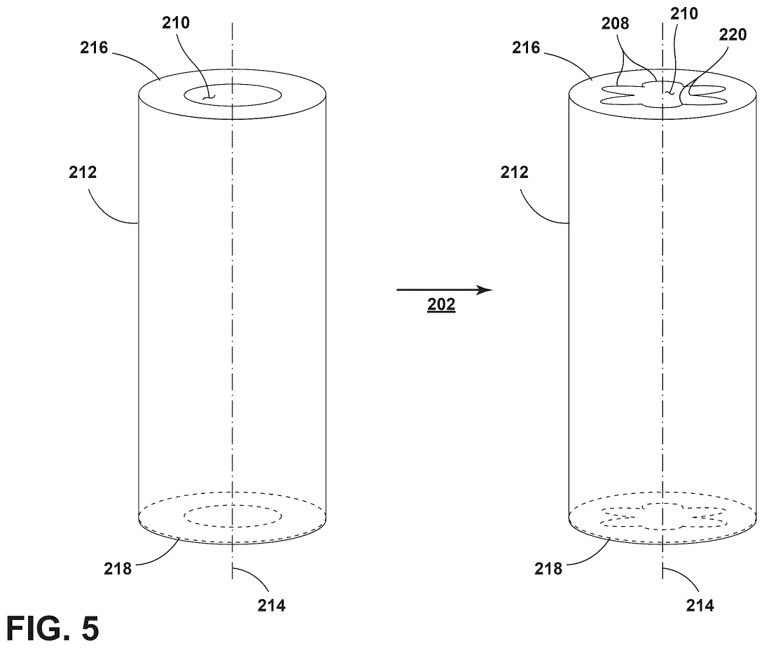

The preform recess formation step 202 (see FIG. 5) includes forming a plurality of preform recesses 208 within a cladding preform inner surface 210 of a cladding preform tube 212 through which a cladding preform longitudinal axis 214 extends. For example, the cladding preform inner surface 210 can initially be cylindrical. The plurality of recesses 208 can then be machined into the cladding preform inner surface 210. Each of the plurality of preform recesses 208 is disposed longitudinally from a first preform end 216 to a second preform end 218 of the cladding preform tube 212. In embodiments, each of the plurality of perform recesses 208 merges with an adjacent preform recess 208 in both azimuthal directions around the preform longitudinal axis so that the cladding preform inner surface 210 forms preform peaks 220 pointing inward toward the cladding preform longitudinal axis 214. In other embodiments, the cladding preform inner surface 201 forms plateaus (not separately illustrated) of constant radius from the cladding preform longitudinal axis 214 between adjacent preform recesses 208 in both azimuthal directions around the preform longitudinal axis 214.

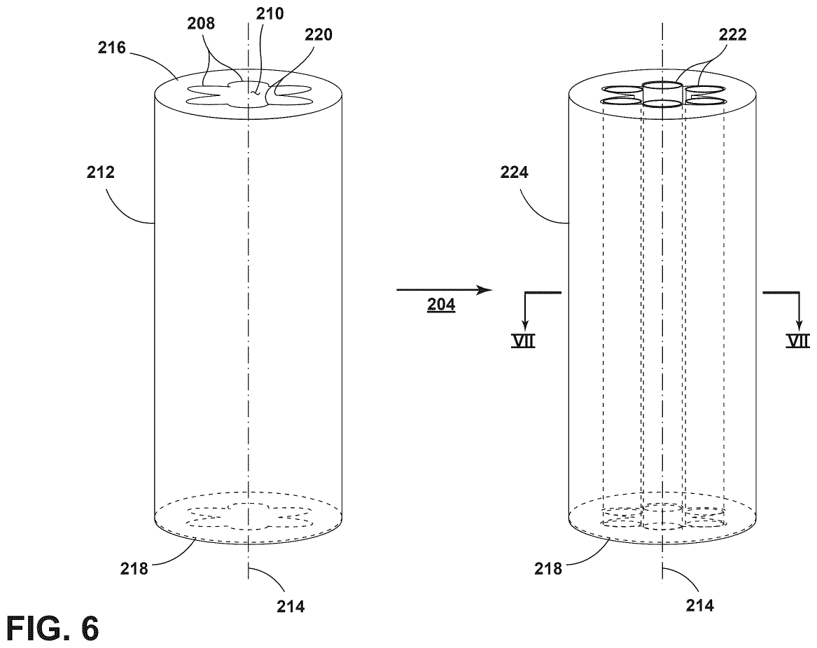

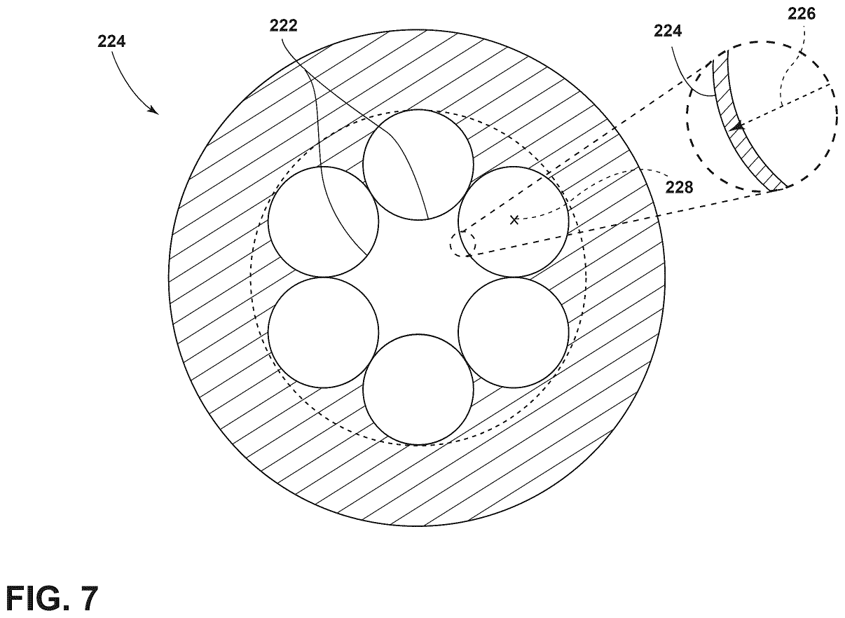

The primary preform capillary arrangement step 204 (see FIGS. 6-7) includes arranging a plurality of primary preform capillaries 222 within the plurality of preform recesses 208 of the cladding preform tube 212. For example, the plurality of primary preform capillaries 222 can be formed and fused (e.g., via flame treatment, laser treatment, among other ways) to the cladding preform inner surface 210 with the plurality of preform recesses 208. The coupling of the plurality of primary preform capillaries 222 to the cladding preform tube 212 forms an optical fiber preform 224. Nested preform capillaries (not separately illustrated) can be similarly formed and fused to the inner surface of the primary preform capillaries 222 either before or after coupling of the plurality of primary preform capillaries 222 to the cladding preform tube 212. Each of the plurality of primary preform capillaries 222 includes an outer primary preform surface 224 at an outer primary preform radius 226 from a primary capillary preform axis 228. The primary capillary preform axis 228 is parallel to the cladding preform longitudinal axis 214. Each of the plurality of primary preform capillaries 222 contacts an adjacent primary preform capillary 222 in both azimuthal directions around the cladding preform longitudinal axis 214. Each of the plurality of primary preform capillaries 222 contacts the cladding preform inner surface 210. The plurality of preform recesses 208 is dimensioned to substantially match the outer primary preform radius 226 of the plurality of primary preform capillaries 222.

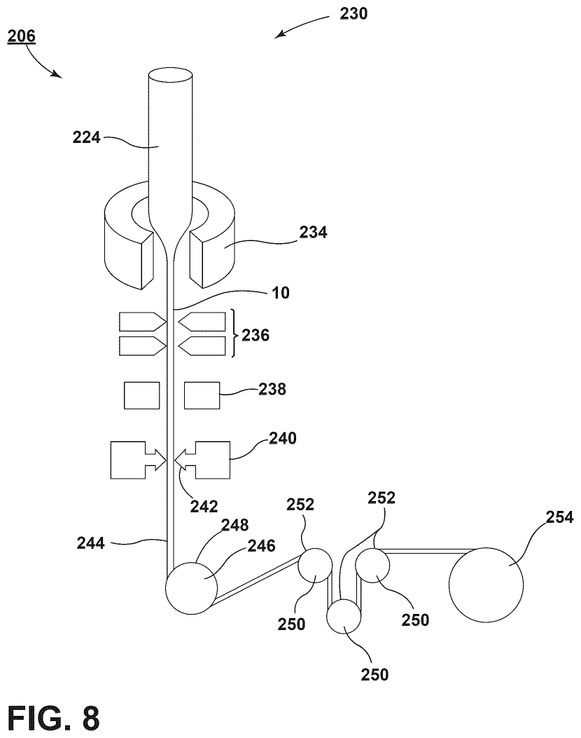

The drawing step 206 includes drawing the anti-resonant hollow core optical fiber 10 from the optical fiber preform 224. The drawing step 206 (see FIG. 8) can be performed using a draw system 230. The draw system 230 can include a furnace for heating the optical fiber preform 224 to melt or soften the cladding preform tube 212 and the plurality of primary preform capillaries 222. The furnace 232 can be disposed in a draw tower. In embodiments, the furnace 232 includes a heater 234 such that the optical fiber preform 224 is consumed and drawn into the anti-resonant hollow core optical fiber 10 as it is lowered towards the heater 234. The draw system 230 can further include non-contact measurement sensors 236 for measuring the size (e.g., cladding outer radius 32) of the anti-resonant hollow core optical fiber 10 that exits the furnace 232. A cooling station 238 can reside downstream of the measurement sensors 236 and is configured to cool the anti-resonant hollow core optical fiber 10. A coating station 240 can reside downstream of the cooling station 238. The coating station 240 is configured to deposit a protective coating material 242 onto the anti-resonant hollow core optical fiber 10 to form a coated anti-resonant hollow core optical fiber 244. A tensioner 246 resides downstream of the coating station 240. The tensioner 246 has a surface 248 that pulls (draws) the coated anti-resonant hollow core optical fiber 244. A set of guide wheels 250 with respective surfaces 252 resides downstream of the tensioner 246. The guide wheels 250 serve to guide the coated anti-resonant hollow core optical fiber 244 to a fiber take-up spool 254 to store the coated anti-resonant hollow core optical fiber 244.

The cladding tube 18, the plurality of primary capillaries 20, the plurality of first nested capillaries 66, and the plurality of second nested capillaries 82 of the anti-resonant hollow core optical fiber 10 can all be made of, or include, silica. The silica of any of the cladding tube 18, the plurality of primary capillaries 20, the plurality of first nested capillaries 66, and the plurality of second nested capillaries 82 can be doped with a viscosity-altering dopant (e.g., nitrogen, fluorine, among other options) as desired to facilitate manufacturing (e.g., draw).

The anti-resonant hollow core optical fiber 10 and the method 200 of the present disclosure address the problems described in the Background, among others, in a variety of ways. For example, the anti-resonant hollow core optical fiber 10 exhibits relatively low confinement loss for the fundamental mode of the electromagnetic radiation 23 within and throughout the wavelength range of from 1500 nm to 1600 nm. The low confinement loss within that wavelength range is desirable because 1550 nm is a common target operating wavelength. The low confinement loss was surprising because the merging or contacting of the plurality of primary capillaries 20 constitutes nodes, which are generally understood in the prior art to increase confinement loss. Without being bound by theory, it is theorized that the presence of nodes induces coupling between the core mode and the dielectric modes within the primary capillaries 20, which themselves leak into the cladding tube 18. The design described herein of the anti-resonant hollow core optical fiber 10 reduces that theorized phenomena by burying the leakage loss from the dielectric modes associated with the primary capillaries 20 within the cladding tube 18 via the plurality of recesses 38. However, the confinement loss that the anti-resonant hollow core optical fiber 10 exhibits was high only for the higher order modes, not the fundamental mode, which is beneficial for production of single mode optical fiber.

In addition, as the Example below will demonstrate, the confinement loss for the fundamental mode exhibited by the anti-resonant hollow core optical fiber 10 does not vary much as a function of overlap among the plurality of primary capillaries 20. As mentioned in the Background, manufacture of the anti-resonant hollow core optical fiber 10 is difficult and variances in relative positioning of the primary capillaries 20 can occur, which would normally cause upward spikes in confinement loss for the fundamental mode as a function of wavelength. Such spikes, however, are not observed for the anti-resonant hollow core optical fiber 10.

Further and related, the design intention that adjacent primary capillaries 20 contact or merge eases manufacturing. Typically, the anti-resonance depends on adjacent primary capillaries 20 not contacting or merging, with an air gap separating them. However, this is difficult to achieve in practice, because as the preform enters the draw furnace 232, gas pressure within the primary capillaries 20 increases, which causes the primary capillaries 20 to expand, which can result in them contacting each other, before the gas pressure decreases and the primary capillaries 20 deflate. That is no longer an issue because adjacent primary capillaries 20 of the anti-resonant hollow core optical fiber 10 are designed to contact or merge.

Moreover, typically, the anti-resonance depends on the plurality of primary capillaries 20 maintaining a precise angle of attachment to the cladding inner surface 30. Manufacture can result in angular variations along the length of the optical fiber. However, with the plurality of recesses 38 cradling the plurality of primary capillaries 20, angular variation is much less likely to occur during the drawing step 206.

### EXAMPLES

Example 1—For the Example 1, an anti-resonant hollow core optical fiber of the design illustrated in FIG. 3A was modeled using the Comsol Multiphysics® finite element software, with the exception that the anti-resonant hollow core optical fiber included five (not six) primary capillaries disposed within five (not six) recesses of the cladding tube. The parameters used for the modeling were as follows: (i) core radius=17.5 μm; (ii) primary outer radius for the primary capillaries=25 μm, (iii) first angle for the plurality of first nested capillaries=95 degrees, (iv) second angle for the plurality of second nested capillaries=95 degrees, (v) first nested outer radius of the plurality of first nested capillaries=10.5 μm, (vi) second nested outer radius of the plurality of second nested capillaries=10.5 μm, (vii) primary thickness of the primary capillaries, first nested thickness of the plurality of first nested capillaries, and second nested thickness of the plurality of second nested capillaries=500 nm.

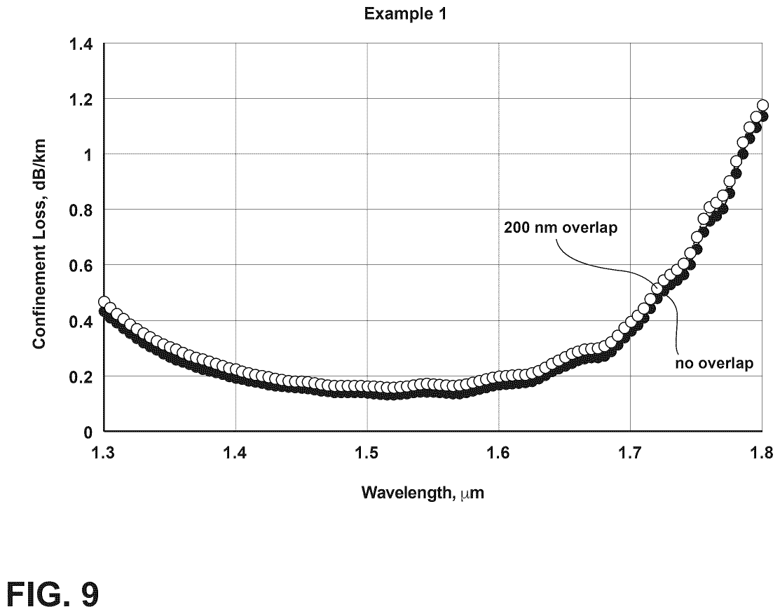

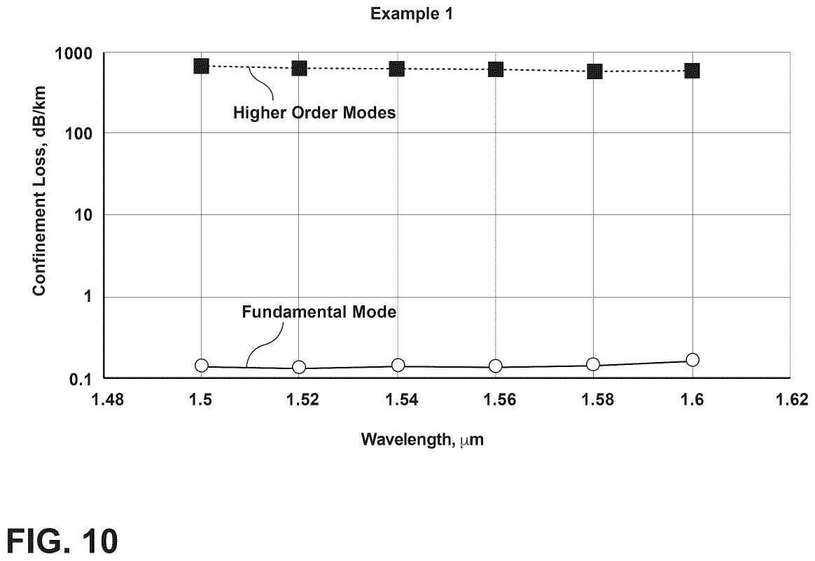

The modeling software then calculated the confinement loss as a function of wavelength of electromagnetic radiation transmitted through the anti-resonant hollow core optical fiber. Confinement loss was additionally calculated assuming an overlap between the primary capillaries and cladding inner surface of 200 nm. The results are reproduced in the graphs of FIG. 9 (fundamental mode) and FIG. 10 (fundamental mode and higher order modes). As the graph of FIG. 9 reveal, the confinement loss spectra for the fundamental mode are relatively smooth without spikes caused by leakage through the primary capillaries. The smooth spectra contrast with other designs known in the prior art where adjacent primary capillaries touch. A minimum confinement loss of 0.14 dB/km for the fundamental mode occurs at a wavelength of about 1550 nm. The confinement loss for the fundamental mode is below 0.2 dB/km throughout the entirety of the wavelength range of from 1500 nm to 1600 nm, below 0.3 dB/km throughout the entirety of the wavelength range of from 1350 nm to 1650 nm, and below 0.5 dB/km throughout the entirety of the wavelength range of from 1300 nm to 1700 nm. The graph of FIG. 10 additionally includes confinement loss for higher order modes, showing the confinement loss to be well above 500 dB/km throughout the entirety of the wavelength range of from 1500 nm to 1600 nm.

Example 2—For Example 2, an anti-resonant hollow core optical fiber of the design illustrated in FIG. 3B was modeled using the Comsol Multiphysics® finite element software, with the exception that the anti-resonant hollow core optical fiber included five (not six) primary capillaries disposed within five (not six) recesses of the cladding tube. The parameters used for the modeling were as follows: (i) core radius=17.5 μm; (ii) primary outer radius for the primary capillaries=25 μm, (iii) first angle for the plurality of first nested capillaries=95 degrees, (iv) second angle for the plurality of second nested capillaries=95 degrees, (v) first nested outer radius of the plurality of first nested capillaries=10.5 μm, (vi) second nested outer radius of the plurality of second nested capillaries=10.5 μm, (vii) primary thickness of the primary capillaries, first nested thickness of the plurality of first nested capillaries, and second nested thickness of the plurality of second nested capillaries=500 nm. In addition, depth was made variable, specifically values of 1 μm, 17 μm, and 33 μm.

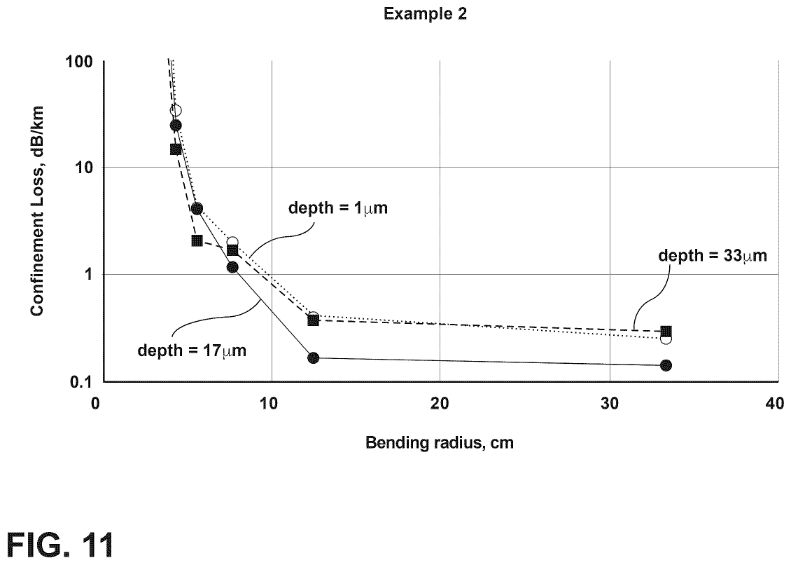

Confinement loss at a wavelength of 1550 nm as a function of bending loss, for each of the depths, was calculated. The results are reproduced in the graph of FIG. 11. As the graph reveals, confinement loss for the fundamental mode remains under 1 dB/km for bending radii over about 10 cm for all of the depths. The middle depth of 17 μm produced the lowest confinement loss.

It will be apparent to those skilled in the art that various modifications and variations can be made without departing from the spirit or scope of the claims.

What is claimed is:

1. An anti-resonant hollow core optical fiber comprising:
a fiber longitudinal axis extending from a first fiber end to a second fiber end;
a cladding tube extending from the first fiber end to the second fiber end azimuthally around the fiber longitudinal axis, the cladding tube comprising (a) a cladding outer surface at a cladding outer radius from the fiber longitudinal axis and (b) a cladding inner surface at a cladding inner radius from the fiber longitudinal axis, wherein the cladding inner radius is azimuthally variable around the fiber longitudinal axis and the cladding inner surface defines a plurality of recesses;
a plurality of primary capillaries arranged azimuthally around the fiber longitudinal axis, each of the plurality of primary capillaries (a) disposed within a different one of the plurality of recesses and contacting the cladding inner surface, (b) contacting or merging with an adjacent primary capillary in both azimuthal directions around the fiber longitudinal axis, and (c) comprising (i) a primary longitudinal axis that is parallel to the fiber longitudinal axis, (ii) a primary outer surface at a primary outer radius from the primary longitudinal axis, and (iii) a primary inner surface at a primary inner radius from the primary longitudinal axis, the primary inner surface defining a primary interior; and
an effective core region tangential to the plurality of primary capillaries at a core radius from the fiber longitudinal axis, the plurality of primary capillaries disposed radially outward of the effective core region.

2. The anti-resonant hollow core optical fiber of claim 1, wherein each of the plurality of recesses merges with an adjacent recess in both azimuthal directions around the fiber longitudinal axis so that the cladding inner surface forms peaks pointing inward toward the fiber longitudinal axis.

3. The anti-resonant hollow core optical fiber of claim 1, wherein the cladding inner surface further defines plateau portions where the cladding inner radius is constant azimuthally around the fiber longitudinal axis, and each of the plurality of recesses are separated from an adjacent recess in both azimuthal directions around the fiber longitudinal axis by a different one of the plateau portions.

4. The anti-resonant hollow core optical fiber of claim 1, wherein the primary outer radius of each of the plurality of primary capillaries is within a range of from 5 μm to 30 μm.

5. The anti-resonant hollow core optical fiber of claim 1, wherein each of the plurality of primary capillaries further comprises a primary thickness that is within a range of from 250 nm to 1500 nm.

6. The anti-resonant hollow core optical fiber of claim 1, wherein each of the plurality of primary capillaries further comprises a primary thickness that is within +30% of a calculated thickness t as defined by the equation:
$$t = \frac{( 2 m - 1 ) λ}{4 \sqrt{{n}^{2} - 1}}$$
where, t is the calculated thickness, m is an integer (e.g., 1, 2, 3, . . . ) corresponding to the order of antiresonance, λ is the operating wavelength, and n is the refractive index of the primary capillaries.

7. The anti-resonant hollow core optical fiber of claim 1, wherein
the cladding tube has from 3 to 9 recesses,
the anti-resonant hollow core optical fiber has from 3 to 9 primary capillaries, and
the quantity of recesses and the quantity of primary capillaries are the same.

8. The anti-resonant hollow core optical fiber of claim 1, wherein the core radius is within a range of from 10 μm to 25 μm.

9. The anti-resonant hollow core optical fiber of claim 1, further comprising:
a capillary region radius that is tangential to the primary outer surface of each of the plurality of primary capillaries but radially outward of the core radius; and
a primary capillary region between the capillary region radius and the core radius, each of the plurality of primary capillaries disposed entirely within the primary capillary region.

10. The anti-resonant hollow core optical fiber of claim 9, wherein bury radial lines extend from the longitudinal axis radially outward through the cladding tube, each of the bury radial lines extending through where different pairs of adjacent primary capillaries contact or merge, and the cladding tube occupies a portion of a volume, outside of the plurality of primary capillaries that is radially inward of the capillary region radius to a depth from the capillary region radius along each of the bury radial longs toward where the adjacent primary capillaries contact or merge.

11. The anti-resonant hollow core optical fiber of claim 10, wherein the depth is from 10% to 85% of a radial distance from the capillary region radius to where the adjacent primary capillaries contact or merge.

12. The anti-resonant hollow core optical fiber of claim 1, further comprising:
a plurality of first nested capillaries extending longitudinally from the first fiber end to the second fiber end, each of the plurality of first nested capillaries (a) disposed within the primary interior of a different one of the plurality of primary capillaries and (b) comprising (i) a first capillary axis that is parallel to the fiber longitudinal axis and (ii) a first nested interior.

13. The anti-resonant hollow core optical fiber of claim 12, wherein each of the plurality of first nested capillaries further comprises a first nested thickness that is within a range of from 250 nm to 1500 nm.

14. The anti-resonant hollow core optical fiber of claim 12, further comprising:
a plurality of second nested capillaries extending longitudinally from the first fiber end to the second fiber end, each of the plurality of second nested capillaries (a) disposed within the primary interior of a different one of the plurality of primary capillaries along with a different one of the plurality of first nested capillaries and (b) comprising (i) a second capillary axis that is parallel to the fiber longitudinal axis and (ii) a second nested interior.

15. The anti-resonant hollow core optical fiber of claim 14, wherein a series of primary radial lines extends from the fiber longitudinal axis through (i) the primary longitudinal axis of each of the plurality of primary capillaries and (ii) the cladding inner surface, and each of the plurality of first nested capillaries is paired with a different one of the plurality of second nested capillaries within a different one of the plurality of primary capillaries, the first nested capillary disposed to one side of the primary radial line and the second nested capillary disposed to another side of the primary radial line.

16. The anti-resonant hollow core optical fiber of claim 15, wherein a first nested radial line extending from the primary longitudinal axis through the first capillary axis forms a first angle within a range of from 70 degrees to 110 degrees relative to the primary radial line.

17. The anti-resonant hollow core optical fiber of claim 16, wherein a second nested radial line extending from the primary longitudinal axis through the second capillary axis forms a second angle within a range of from 70 degrees to 110 degrees relative to the primary radial line.

18. The anti-resonant hollow core optical fiber of claim 1, wherein the anti-resonant hollow core optical fiber exhibits a confinement loss for the fundamental mode of electromagnetic radiation throughout an entirety of a wavelength range of from 1500 nm to 1600 nm that is less than or equal to 0.50 dB/km and the anti-resonant hollow core optical fiber exhibits a confinement loss for higher order modes of electromagnetic radiation throughout an entirety of a wavelength range of from 1500 nm to 1600 nm that is greater than or equal to 100 dB/km.

19. A method of manufacturing an anti-resonant hollow core optical fiber comprising:
a preform recess formation step comprising forming a plurality of preform recesses into a cladding preform inner surface of a cladding preform tube through which a cladding preform longitudinal axis extends, each of the plurality of preform recesses disposed longitudinally from a first preform end to a second preform end of the cladding preform tube;
a primary preform capillary arrangement step comprising arranging a plurality of primary preform capillaries within the plurality of preform recesses of the cladding preform tube thus forming an optical fiber preform, each of the plurality of primary preform capillaries (i) comprising an outer primary preform surface at an outer primary preform radius from a primary capillary preform axis parallel to the cladding preform longitudinal axis, (ii) contacting an adjacent primary preform capillary in both azimuthal directions around the cladding preform longitudinal axis, and (iii) contacting the cladding preform inner surface, wherein, the plurality of preform recesses is dimensioned to substantially match the outer primary preform radius of the plurality of primary preform capillaries; and
a drawing step comprising drawing an anti-resonant hollow core optical fiber from the optical fiber preform.

20. The method of claim 19, wherein each of the plurality of preform recesses merge with an adjacent preform recess in both azimuthal directions around the preform longitudinal axis so that the cladding preform inner surface forms peaks pointing inward toward the cladding preform longitudinal axis.
